(19) United States
(12) Patent Application Publication
(10) Pub. No.: US 2001/0054052 A1
(43) Pub. Date: Dec. 20, 2001

(54) Method and apparatus for the calculation of modular multiplicative inverses

(76) Inventor: Benjamin Arazi, Omer (IL)

Correspondence Address: Stroock & Stroock & Lavan LLP, 180 Maiden Lane, New York, NY, 10038-4982, US

(21) Appl. No.: 09/816,184

(22) Filed: Mar. 22, 2001

(30) Foreign Application Priority Data
Mar. 23, 2000 (IL) 135247

(51) Int. Cl. G06F 7/38

(52) U.S. Cl. 708/491

(57) ABSTRACT

Method and apparatus for calculating the modular multiplicative inverse of an element of a Galois Field GF(2n).

### FIELD OF THE INVENTION

The present invention relates to a method and apparatus for efficiently calculating modular multiplicative inverses over the Galois Field GF(2ⁿ).

### BACKGROUND OF THE INVENTION

The calculation of modular multiplicative inverses of elements of the Galois field GF(2n) has importance in applications like the implementations of ECC (Elliptic Curve Cryptography) operations.

The elements of the Galois Field GF(2ⁿ) are polynomials of degree n−1 or less, which involve operations over a generating polynomial g(x) of degree n, as will be clear to persons skilled in the art.

Modular multiplicative inverse calculation can be based on exponentiations such as indicated in G. B. Agnew et al., “An Implementation of Elliptic Curve Cryptosystems over F₂¹⁵⁵”, IEEE J. on Sel. Areas in Communications, 1993, pp. 804-813, or on the Euclid algorithm. Euclid-based calculations of the modular multiplicative inverse of an element of the Galois Field GF(2ⁿ) are shown in E. R. Berlekamp, Algebraic Coding Theory, McGraw-Hill, 1968, pp. 36-44.

Euclid-based calculations of the modular multiplicative inverse of an element of the Galois Field GF(2ⁿ) are based, in principle, on having registers R0, R1, R2 and R3, wherein a shift of registers R0 and R1 shifts out the least significant bit and wherein a shift of registers R2 and R3 divides their contents by x modulo, generating polynomial g(x). Register R0 is capable of storing n+1 bits and initially stores the coefficients of the generating polynomial g(x). Said registers R1, R2 and R3 are capable of storing n bits, where register R1 initially stores the element b(x) of the field whose modular multiplicative inverse is to be calculated. Registers R2 and R3 initially store, respectively, zeros and a single 1 at the least significant place (e.g., least significant bit).

A prior art process for calculating the modular multiplicative inverse of an element b(x) is based on shifting said registers R0 or R1 whenever any of the registers has a bit of value 0 at the least significant place. When both said registers have a bit of value 1 at the least significant place, the contents of the register with the ‘shorter’ contents is added to the contents of the other register, where the ‘length’ of the contents of a register is measured in terms of the distance between the two extreme bits of value 1 stored in the register while the least significant bit is of value 1, and where the addition is a logic ‘xor’ operation. The process terminates when any of registers R0 or R1 contains a single bit of value 1 at the least significant place. The occurrence of one of said two possibilities is guaranteed, due to the fact that g(x) and b(x) are relatively prime, which stems from the fact that g(x) is primitive, as will be clear to persons skilled in the art. During the execution of the process, registers R2 and R3 follow respectively the activities of said registers R0 and R1. That is, when R0 or R1 are shifted, then R2 or R3 are respectively shifted. When the contents of R0 are added to those of R1, then the contents of R2 are added to those of R3, and vice versa. Upon the termination of the process, if R0 is the register that contains said single 1 bit, then the contents of register R2 is the desired modular multiplicative inverse of said b(x). If R1 is the register that contains single 1 bit, then the contents of register R3 is the desired modular multiplicative inverse of said b(x).

Apparatus for the calculation of modular multiplicative inverse is described in U.S. Pat. No. 6,009,450 to Dworkin, entitled Finite Field Inverse Circuit, the entire content and disclosure of which is hereby incorporated by reference. Said apparatus is characterized by having two counters and additional circuitry needed for the processing of the difference between the values stored in the two counters.

There is still a need in the art for improved methods and apparatus for the efficient calculation of modular multiplicative inverse over the Galois Field GF(2ⁿ). It is a purpose of the present invention to provide such improved methods and apparatus.

### SUMMARY OF THE INVENTION

In a co-pending patent of the same applicant hereof (PCT/IL99/00699) a method and apparatus are described which substantially improve over the prior art in as much as two counters are used without any processing of their contents. In the present invention a further significant improvement is provided in as much as the invention permits also to avoid the need to use the two counters that were previously required.

In one aspect, the present invention is directed to a method for calculating the modular multiplicative inverse of an element of a Galois Field GF(2ⁿ) comprising the steps of:

providing a first (R0), a second (R1), a third (R2) and a fourth (R3) register, wherein the first register stores n+1 bits, and wherein the second, third and fourth registers store n bits;

causing the third and fourth registers to carry out, by a single shift, a division operation by x modulo the generating polynomial (g(x)) of the Galois Field;

storing in the first register the generating polynomial (g(x)) of the Galois Field;

storing in the second register the field element to be inverted; storing zeros in said third register;

storing in the least significant cell (bit) of the fourth register a 1 bit and storing zeros in the rest of the cells (bits) of the fourth register;

adding the contents of the second register (R1) to the contents of the first register (R0) while adding simultaneously the contents of the fourth register (R3) to the contents of the third register (R2) when a bit of value 1 is stored in the least significant place of the first register;

adding the contents of the first register (R0) to the contents of said second register (R1) while adding simultaneously the contents of the third register (R2) to the contents of the fourth register (R3) when a bit of value 1 is stored in the cell (bit) with the highest index where such a bit exists in the second register; and

carrying out simultaneously shift operations on the first register and the third register;

carrying out simultaneously shift operations on the second register and the fourth register;

thereby to count the value of only one decreasing value (h) and to convert, into 0, bits of value 1 in the second register from both the highest index and from the lowest index where such bits exist in the register.

The present invention further comprises an apparatus for calculating the modular multiplicative inverse of an element of the Galois Field GF(2ⁿ), comprising registers and control circuitry provided with down counter (decrementer) circuitry, wherein the control circuitry comprises only one down-counter (decrementer).

In another embodiment, aspect the present invention is directed to an apparatus for calculating the modular multiplicative inverse of an element of the Galois Field GF(2ⁿ), comprising a plurality of registers and control circuitry, wherein one register out of the plurality of registers is suitable to store initially the field element to be inverted, and wherein the control circuitry is suitable to convert, into 0, bits of value 1 in said register from both the highest index and from the lowest index where such bits exist in the register.

In yet another embodiment the present invention is directed to an apparatus for calculating the modular multiplicative inverse of an element of the Galois Field GF(2ⁿ), comprising:

a first register (R0) for storing n+1 bits;

a second register (R1) for storing n bits; a third register (R2) for storing n bits;

a fourth register (R3) for storing n bits;

a down-counter (decrementer);

circuitry for shifting the second and fourth registers (R1 and R3), wherein a shift of the second register (R1) shifts out the least significant bit while a bit of value 0 is inserted into the cell (bit) with the highest index, and wherein the shift of the fourth register (R3) divides its contents by x modulo the generating polynomial of the Field, where the shifting of the second and fourth registers is effected when the least significant bit (R1₀) of the second register equals 0;

circuitry for shifting the first and third registers (R0 and R2), wherein a shift of the first register (R0) shifts out the least significant bit while a bit of value 0 is inserted into the cell with the highest index, and wherein the shift of the third register (R2) divides its contents by x modulo the generating polynomial of the Field, and while decreasing by one count the contents of the down counter, where the shifting of the first and third registers is effected when the least significant bit (R0₀) of said first register equals 0;

circuitry for adding the contents of the second register (R1) to those of the first register (R0) and for adding the contents of the fourth register (R3) to those of the third register (R2), where the additions are effected when the least significant bit (R0₀) of the first register equals 1; and

circuitry for adding the contents of the first register (R0) to those of the second register (R1) and for adding the contents of the third register (R2) to those of the fourth register (R3), where the additions are effected when the bit (R1ₕ) of the second register, whose location is indicated by the contents of the down-counter, equals 1.

### BRIEF DESCRIPTION OF THE DRAWINGS

In the drawings:

FIG. 1 shows in a flow chart form a preferred method according to an embodiment of the present invention for the calculation of modular multiplicative inverse of an element of the arithmetic Galois Field GF(2ⁿ);

FIG. 2 shows a preferred apparatus according to an embodiment of the present invention for the calculation of modular multiplicative inverse of an element of the arithmetic field Galois Field GF(2ⁿ); and

FIG. 3 illustrates a shift register which performs a division operation modulo a generating polynomial g(x).

### DETAILED DESCRIPTION OF PREFERRED EMBODIMENTS

The present invention provides improved methods for calculating modular multiplicative inverses over the Galois Field GF(2ⁿ). The invention further provides apparatus for calculating modular multiplicative inverses over the field Galois Field GF(2ⁿ).

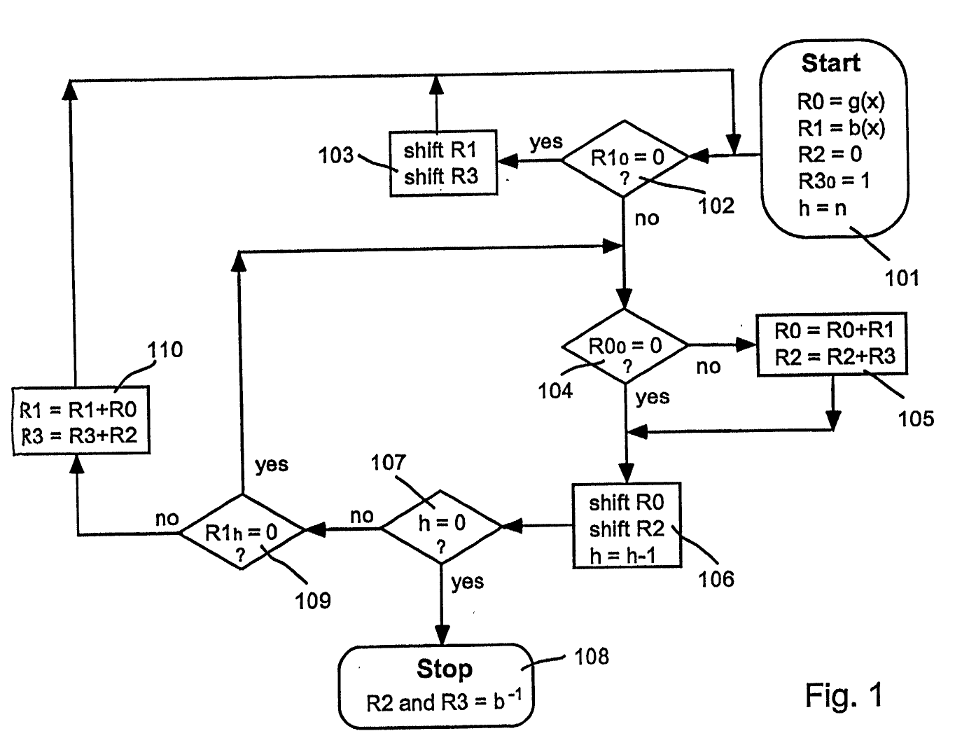

The function of the method of the present invention for calculating modular multiplicative inverses over the Galois Field GF(2ⁿ) according to a first embodiment of the invention is shown in FIG. 1 and is better understood from observing the following Pseudo-Code 1, which executes substantially the same process. Comments under Pseudo-Code 1 and the explanation which follows it further clarify the method of the invention.

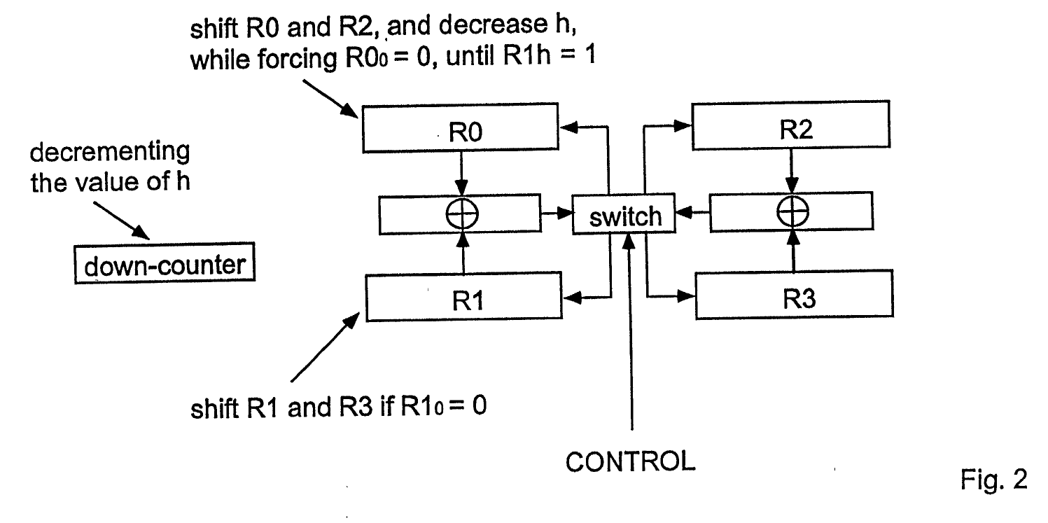

Registers R0, R1, R2 and R3, depicted in FIG. 2, are shift registers, wherein a shift of R0 and R1 shifts out the least significant bit while a bit of value 0 is inserted into the cell with the highest index. A shift of R2 or R3 divides the contents of R2 or R3 by x modulo the generating polynomial g(x) of the Galois Field GF(2ⁿ). Register R0 is capable of storing n+1 bits, and said registers R1, R2 an R3 are capable of storing n bits.

Hereinafter, R0j or R1j denotes, respectively, the bit with index j in register R0 or R1, wherein the index of the least significant bit is 0.

Pseudo-code 1

The following lines of code (including comments), referred to as Pseudo-Code 1, is exemplary of code necessary to carry-out the present invention in connection with a suitable computing device, such as are generally known to persons skilled in the art.

A method for calculating the modular multiplicative inverse of an element of the Galois Field GF(2ⁿ) will now be discussed with reference to FIG. 1.

Initially, (as indicated in 101 in FIG. 1), R0 contains the coefficients of the polynomial g(x), R1 contains the element b(x) of the field GF(2ⁿ) which is to be inverted, R2 contains zeros, R3 contains a 1 at the least significant place (that is, R3₀=0), and h is set to n. Throughout the execution of the process depicted in FIG. 1, h is the highest index of the bit of value 1 in R0. The value of h is decreased during the process. The process terminates when h=0. Initially it is guaranteed that R0ₙ=1, since the degree of g(x) is n; that is, initially h=n.

1 If R1₀=0 then (shift R1 and R3 and go to 1) else go to 2.

(as indicated in 102 and 103 in FIG. 1).

Comment: The above loop shifts R1 and R3 until the least significant bit in R1 is 1.)

2 If R0₀=1 then (R0=R0+R1 and R2=R2+R3) else go to 3

(as indicated in 104 and 105 in FIG. 1).

Comment: All +notations mean a logic ‘xor’ operation. After step 2, R0₀=0.

3 shift R0 and R2 h=h−1

(as indicated in 106 in FIG. 1)

4 If h=0 Stop (The contents of each of R2 or R3 is b⁻¹(x).) else go to 5

(as indicated in 107 and 108 in FIG. 1).

Comment: If h=0, R0₀=R1₀ =1 and the rest of the bits in R0 and R1 are 0.

5 If R1ₕ=0 then (go to 2) else go to 6

(as indicated in 109 in FIG. 1).

Comment: The above loop shifts R0 and R2, after it was taken care that the least significant bit in R0 before the shift is 0; the shift operation continues until the h-th bit of R0, which by definition has the value 1, is positioned across the bit of value 1 with the highest index in R1. (The index of said latter bit, in R1, is also h.)

6 R1=R1+R0 R3=R3+R2 go to 1

(as indicated in 110 in FIG. 1).

Comment: After the above is executed, R1ₕ=0. This way, R1 becomes shorter in the sense that the bit of value 1 with the highest index in R1, gets closer to the least significant place. There is a further possibility that the least significant bit in R1 was also converted into a 0 by the operation R1=R1+R0, which brings the process back to stage 1.

The validity of the inventive method presented in Pseudo-Code 1 according to a first embodiment of the invention is still based on the Euclid algorithm, where registers R2 and R3 follow respectively the activities of registers R0 and R1. That is, when R0 or R1 are shifted, then R2 or R3 are respectively shifted while executing a division by x modulo the generating polynomial g(x). When the contents of R0 are added to those of R1, then the contents of R2 are added to those of R3, and vice versa. This is where the similarity between the method of the invention and prior art implementations of the Euclid algorithm ends.

The method according to a first embodiment of the present invention facilitates the shortening of the contents of R1 by converting into 0, one at a time, the bit of value 1 with the highest index in R1. As was defined, the contents of R1 is shortened in the sense of shortening the distance between the two extreme bits of value 1 stored in R1, while the least significant bit of R1 is of value 1. Whenever the least significant bit in R1 is 0, R1 is shifted and said 0 is canceled. By definition, the initial value of the n-th bit in R0 is 1. This bit ‘slides’ across R1, via shifts of R0, and cancels bits of value 1 in R1, from the highest index downwards. The shifts of R0 are effected by forcing the least significant bit in R0 to be 0 before the shift is effected.

A clear feature of the method presented in Pseudo-Code 1 according to a first embodiment of the present invention, concerns cancellations of 1 bits with the highest index in R1, while shifting R1 in the case there is a least significant bit of value 0 in R1. Cancellation of 1 bit means the conversion of a bit of value 1 into 0. This way, bits of value 1 are canceled from both the highest index and from the lowest index where such bits exist in said second register of R1. Thus, R1 is added to R0 in order to cancel a least significant bit of value 1 in R0, while R0 is added to R1 in order to cancel the bit with value 1 with the highest index in R1. This feature of said method distinctly differs said method from prior art implementations of the Euclid algorithm in which only least significant bits of value 1 in either register R0 or R1 are canceled.

A further clear feature of the method presented in Pseudo-Code 1 according to a first embodiment of the present invention, which distinguishes this inventive method from prior art implementations of the Euclid algorithm and which is a practical consequence of the preceding feature, concerns the counting of only one dynamically changing value (h).

A preferred apparatus according to an embodiment of the invention, for implementing the method presented in Pseudo-Code 1, is shown in FIG. 2. The apparatus preferably comprises a first, second, third and fourth registers, respectively denoted as R0, R1, R2 and R3, where R0 stores n+1 bits and the other three registers store n bits, and a down-counter (decrementer) whose initial value is set to n and whose functioning is to count the value of h, where registers and down-counter are effected by the following operations:

A first operation, in which second and fourth registers R1 and R3 are shifted, wherein a shift of second register R1 shifts out the least significant bit while a bit of value 0 is inserted into the cell with the highest index, and wherein the shift of said fourth register (R3) divides its contents by x modulo a generating polynomial g(x), where the first operation is effected when the least significant bit (R1₀) of the second register R1 equals 0;

A second operation, in which said first and third registers R0 and R2 are shifted, wherein a shift of first register R0 shifts out the least significant bit while a bit of value 0 is inserted into the cell with the highest index, and wherein the shift of third register R2 divides its contents by x modulo the generating polynomial g(x) and while decreasing by one count the contents of the down-counter, where the second operation is effected when the value of the least significant bit (R0₀) of the first register R0 equals 0;

A third operation, in which the contents of second register R1 are added to those of first register R0 and the contents of fourth register R3 are added to those of third register R2, where the third operation is effected when the value of the least significant bit (R0₀) of first register R0 equals 1;

A fourth operation, in which the contents of first register R0 are added to those of second register R1 and the contents of third register R2 are added to those of fourth register R3, where the fourth operation is effected when the value of the bit of second register R1, whose location is indicated by the contents of the down-counter (R1ₕ), equals 1.

The above-described four operations effect the operation of calculating the modular multiplicative inverse of an element of the Galois Field GF(2ⁿ), described in the Pseudo-Code 1 provided above, as follows: The operation indicated in the Pseudo-Code 1 by “If R1₀=0 then shift R1 and R3” is preferably effected by said first operation. The operation indicated in the Pseudo-Code 1 by “If R0₀=1 then R0 =R0+R1 and R2=R2+R3” is preferably effected by the third operation. The operation indicated in the Pseudo-Code 1 by “shift R0 and R2, h=h−1” is preferably effected by the second operation. The operation indicated in the Pseudo-Code 1 by “R1=R1+R0 and R3=R3+R2” is preferably effected by the fourth operation.

An alternative embodiment of the present invention is disclosed by way of exemplary Pseudo-Code 2.

Pseudo-code 2

A method for calculating the modular multiplicative inverse of an element of the Galois Field GF(2ⁿ) according to a second embodiment of the present invention will now be described with reference to Pseudo-Code 2, which is exemplary of code necessary to carry-out the present invention in connection with a suitable computing device, such as are generally known to persons skilled in the art.

Initially, R0 contains the coefficients of said polynomial g(x), R1 contains the element b(x) of the field GF(2ⁿ) which is to be inverted, R2 contains zeros, R3 contains a 1 at the least significant place, (that is, R30=0), and h is set to n.

1 If R1₀=0 then (shift R1 and R3 and go to 1) else go to 2

2 If all the bits in R1, except for R1₀, are 0: Stop (The contents of R3 is b⁻¹(x).) else go to 3

3 If R0₀=1 then (R0=R0+R1 and R2=R2+R3) else go to 4

4 Shift R0 and R2 h=h−1

5 If R1ₕ=0 then (go to 3) else go to 6

6 R1=R1+R0 R3=R3+R2 go to 1

The embodiment presented in Pseudo-Code 2 differs from the embodiment presented in Pseudo-Code 1 only in the way the process stops.

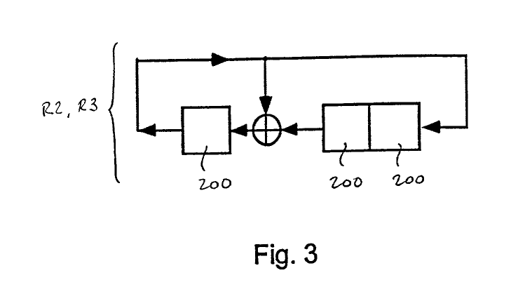

FIG. 3 exemplifies the structure and functioning of registers R2 and R3, each having a plurality of cells 200 within which a bit of data may be stored (and including a least significant cell, bit or place, and a most significant cell, bit or place) for the case where the generating polynomial g(x) is the polynomial 1+x+x³. Each shift of registers R2 and R3 divides their contents by x modulo said generating polynomial g(x), as will be clear to persons skilled in the art. Such register, shown in FIG. 3, is well known in the art and is therefore not discussed herein in detail, for the purpose of brevity.

While some embodiments of the invention have been described by way of illustration, it will be apparent that the invention can be carried into practice with many modifications, variations and adaptations and with the use of the numerous equivalents or alternative solutions that are within the scope of persons skilled in the art, without departing from the spirit of the invention or exceeding the scope of the claims.

What is claimed is:

1. A method for calculating the modular multiplicative inverse of an element of a Galois Field GF(2ⁿ) comprising the steps of:
providing a first (R0), a second (R1), a third (R2) and a fourth (R3) register, wherein said first register stores n+1 bits, and wherein said second, third and fourth registers store n bits;
causing said third (R2) and fourth (R3) registers to carry out, by a single shift, a division operation by x modulo the generating polynomial (g(x)) of said Galois Field;
storing in said first register (R0) said generating polynomial (g(x)) of said Galois Field;
storing in said second register (R1) the element to be inverted;
storing zeros in said third register (R2);
storing in the least significant cell of said fourth register (R3) a 1 bit and storing zeros in the rest of the cells of said fourth register (R3);
adding the contents of said second register (R1) to the contents of said first register (R0) while adding simultaneously the contents of said fourth register (R3) to the contents of said third register (R2) when a bit of value 1 is stored in the least significant place of said first register (R0);
adding the contents of said first register (R0) to the contents of said second register (R1) while adding simultaneously the contents of said third register (R2) to the contents of said fourth register (R3) when a bit of value 1 is stored in the cell with the highest index where such a bit exists in said second register (R1);
carrying out simultaneously shift operations on said first register (R0) and said third register;
carrying out simultaneously shift operations on said second register (R1) and said fourth register (R3); and so as to count the value of only one decreasing value (h) and to convert, into 0, bits of value 1 in said second register (R1) from both the highest index and from the lowest index where such bits exist in said second register (R1).

2. An apparatus for calculating the modular multiplicative inverse of an element of the Galois Field GF(2ⁿ), comprising registers and control circuitry, wherein said control circuitry comprises only one down-counter (decrementer).

3. An apparatus for calculating the modular multiplicative inverse of an element of a Galois Field GF(2ⁿ), comprising a plurality of registers and control circuitry, wherein one register out of said plurality of registers is suitable to store initially the element to be inverted, and wherein said control circuitry is suitable to convert, into 0, bits of value 1 in said register from both a highest index and from a lowest index where such bits exist in said one register.

4. An apparatus for calculating the modular multiplicative inverse of an element of a Galois Field GF(2ⁿ), comprising:
a first register (R0) for storing n+1 bits;
a second register (R1) for storing n bits; a third register (R2) for storing n bits;
a fourth register (R3) for storing n bits;
a down-counter (decrementer);
circuitry for shifting said second and fourth registers (R1 and R3), wherein a shift of said second register (R1) shifts out the least significant bit of said second register (R1) while a bit of value 0 is inserted into the cell with the highest index, and wherein the shift of said fourth register (R3) divides its contents by x modulo the generating polynomial of said Galois Field, where said shifting of said second and fourth registers (R1 and R3) is effected when the least significant bit (R1₀) of said second register (R1) equals 0;
circuitry for shifting said first and third registers (R0 and R2), wherein a shift of said first register (R0) shifts out the least significant bit of said first register (R0) while a bit of value 0 is inserted into the cell with the highest index, and wherein the shift of said third register (R2) divides its contents by x modulo the generating polynomial of said Galois Field, and while decreasing by one count the contents of said down-counter, where said shifting of said first and third registers (R0 and R2) is effected when the least significant bit (R0₀) of said first register (R) equals 0;
circuitry for adding the contents of said second register (R1) to those of said first register (R0) and for adding the contents of said fourth register (R3) to those of said third register (R2), where said additions are effected when the least significant bit (R0₀) of said first register (R0) equals 1; and
circuitry for adding the contents of said first register (R0) to those of said second register (R1) and for adding the contents of said third register (R2) to those of said fourth register (R3), where said additions are effected when the bit (R1ₕ) of said second register (R1), whose location is indicated by the contents of said down-counter, equals 1.
